(19) United States
(12) Patent Application Publication
(10) Pub. No.: US 2011/0276342 A1
(43) Pub. Date: Nov. 10, 2011

(54) VALIDATION OF POINT-OF-CARE TEST RESULTS BY ASSESSMENT OF EXPECTED ANALYTE RELATIONSHIPS

(75) Inventor: Steven C. KAZMIERCZAK, Portland, OR (US)

(73) Assignee: Abaxis, Inc., Union City, CA (US)

(21) Appl. No.: 13/102,394

(22) Filed: May 6, 2011

Related U.S. Application Data
(60) Provisional application No. 61/332,154, filed on May 6, 2010.
(60) Provisional application No. 61/378,668, filed on Aug. 31, 2010.

(51) Int. Cl. G06Q 50/00

(52) U.S. Cl. 705/2

(57) ABSTRACT

Methods for determining the validity or accuracy of a clinical test result are provided. The methods entail obtaining patient analyte concentration data for two or more analytes with a concentration relationship; calculating a likelihood distribution for the concentration relationship between the two or more analytes; obtaining a clinical test result comprising measured concentration values for the two or more analytes; and determining the validity or accuracy of the clinical test result based on whether the clinical test result falls within the boundaries of the likelihood distribution. Analyte pairs that can be analyzed by the methods of the invention include albumin/calcium, sodium/chloride, BUN/creatinine, AST/ALT, total protein/albumin, potassium/total CO₂, calcium/phosphorus, calcium/magnesium, potassium/creatinine, magnesium/potassium, Anion gap/potassium, sodium/potassium, chloride/potassium, magnesium/phosphate, ALT/GGT, ALT/ALP, CK/LDH and chloride/total CO₂.

### CROSS-REFERENCE TO RELATED APPLICATIONS

This application claims priority to U.S. Provisional Application Ser. No. 61/332,154, filed May 6, 2010 and U.S. Provisional Application Ser. No. 61/378,668, filed Aug. 31, 2010, both of which are herein incorporated by reference in their entireties.

### BACKGROUND OF THE INVENTION

The accuracy of patient-derived data generated by the clinical laboratory is critical for optimum patient care and patient safety. The clinical utility of laboratory data can be adversely impacted by a variety of factors. Some of these factors include preanalytical issues such as in vitro hemolysis, use of the incorrect tube type for collection of blood, and contamination of specimens by intravenous fluid. Additionally, inaccurate results can occur due to the addition of insufficient sample to the reaction mixture, or the improper dilution of a sample. Although these types of errors can be caught by data technicians, clinical chemistry analyzers and instruments cannot reliably detect these types of samples.

While analysis of quality control material can identify instrument or reagent-related problems, it cannot help identify preanalytical problems, which account for the vast majority of inaccurate test results. In fact, studies have shown that errors occur more frequently in the pre- and postanalytical phases of the testing process, rather than the analytical phase itself (Kazmierczak et al. (2007). Clin Chem Lab Med, V. 45, pp. 749-752 citing Plebani M. (2006). Clin Chem Lab Med, V. 44, pp. 750-759). However, studies designed to probe laboratory error, in most cases, assess only one specific type of error that might occur in the total testing process, and therefore, does not address all types of error that may occur (Clin Chem Lab Med, V. 45, pp. 749-752).

Other methods that have been used to help validate the appropriateness/accuracy of test results include the establishment of limit checks to flag physiologically improbable results, delta checking methods, calculation of average-of-normals, and anion gap calculations. However, each of these methods suffers from shortcomings. For example, these methods employ complex algorithms and often are difficult to implement. Additionally, rule based systems are not robust, and therefore, only catch the most egregious of errors (Clin Chem Lab Med, V. 45, pp. 749-752).

Although methods for detecting errors in measurements have been established, there still exists a need in the art for methods that can accurately discard test results due to preanalytical issues. The present invention addresses this and other needs.

### SUMMARY OF THE INVENTION

In one embodiment, the present invention is directed to a method for determining the validity or accuracy of a first clinical test result. The method comprises comparing the first clinical test result of a first analyte and its corresponding second clinical test result of a second analyte to a predetermined likelihood distribution for the first analyte and second analyte, and determining the validity of the first clinical test result based on its relationship with the likelihood distribution.

In another embodiment, a method for determining the validity or accuracy of a first clinical test result is provided. The method comprises comparing the first clinical test result of a first analyte and its corresponding second clinical test result of a second analyte to a predetermined likelihood distribution for the first analyte and second analyte, and determining the validity of the first clinical test result based on its relationship with the likelihood distribution, wherein the first clinical test result is invalid if it is outside of the predetermined likelihood distribution and valid if it is inside of the predetermined likelihood distribution.

In one embodiment, the first analyte and its corresponding second analyte are selected from the group consisting of direct bilirubin/total bilirubin, HDL/total cholesterol, LDL/total cholesterol, HDL/LDL, albumin/calcium, sodium/chloride, BUN/creatinine, AST/ALT, total protein/albumin, potassium/total CO₂, calcium/phosphorus, calcium/magnesium, potassium/creatinine, magnesium/potassium, Anion gap/potassium, sodium/potassium, chloride/potassium, magnesium/phosphate, ALT/GGT, ALT/ALP, CK/LDH and chloride/total CO₂.

In another embodiment, a database is provided which comprises a collection of predetermined clinical test results for a first analyte and a corresponding second analyte, wherein the clinical test result of the first analyte correlates with the clinical test result of the second analyte. In a further embodiment, the database is in computer readable medium.

In another embodiment, the present invention is directed to a method for determining a likelihood distribution for a first analyte clinical test result and its corresponding second analyte clinical test result. The method comprises identifying a plurality of clinical test results for the first analyte and its corresponding second analyte, sorting the clinical test results based on the results for the second analyte, grouping the sorted data into a plurality of bins, identifying a confidence interval for the first analyte clinical test result values for each bin, and determining the likelihood distribution based on the clinical test results within the confidence intervals.

In a further embodiment, first analyte and its corresponding second analyte are selected from the group consisting of direct bilirubin/total bilirubin, HDL/total cholesterol, LDL/total cholesterol, HDL/LDL, albumin/calcium, sodium/chloride, BUN/creatinine, AST/ALT, total protein/albumin, potassium/total CO₂, calcium/phosphorus, calcium/magnesium, potassium/creatinine, magnesium/potassium, Anion gap/potassium, sodium/potassium, chloride/potassium, magnesium/phosphate, ALT/GGT, ALT/ALP, CK/LDH and chloride/total CO₂.

### BRIEF DESCRIPTION OF THE FIGURES

FIG. 1 is a graph showing the central 97.5% confidence intervals for sodium as a function of measured chloride concentration. Data from patient samples falling above the upper curve and below the lower curve are measurement errors.

FIG. 2 is a graph showing the central 97.5% confidence intervals for sodium as a function of measured chloride concentration values for inpatients (“×” values) and outpatients (“+” values). Curves were fit to both the upper confidence limits and confidence lower limits to establish the boundaries of the likelihood distributions.

FIG. 3A is a graph showing the central 97.5% confidence intervals for calcium concentration as a function of measured albumin concentration in patients with normal renal function. Curves were fit to both the upper confidence limits and confidence lower limits to establish the boundaries of the likelihood distribution.

FIG. 3B is a graph showing the central 97.5% confidence intervals for calcium concentration as a function of measured albumin concentration in patients with impaired renal function. Curves were fit to both the upper confidence limits and lower confidence limits to establish the boundaries of the likelihood distribution.

### DETAILED DESCRIPTION OF THE INVENTION

### Definitions

As used herein, “confidence interval” means a particular kind of interval estimate of a population parameter. For the present invention, the population parameter is one or more analyte concentration values or abundance values (for one or more analytes, e.g., a patient's sodium concentration) associated with a distinct analyte concentration value (for a different analyte, e.g., the same patient's chloride concentration). Instead of estimating the parameter by a single value, an interval likely to include the parameter is given. Thus, confidence intervals are used to indicate the reliability of an estimate. How likely the interval is to contain the parameter is determined by the confidence level or confidence coefficient.

The end points of the confidence interval are referred to as confidence limits. For example, at a 90% confidence level with a lower limit A and higher limit B, 90% of the population lies between A and B. Of the remaining 10% of values, 5% are less than A and 5% are greater than B. At a 97.5% confidence level with a lower limit A and higher limit B, 97.5% of the population lies between A and B. Of the remaining 2.5% of values, 1.25% are less than A and 1.25% are greater than B.

Confidence intervals are determined as follows, using a 97.5% confidence interval as an example. Individual patient paired analyte data (e.g., sodium and chloride concentrations) is sorted from highest concentration to lowest concentration (or vice versa) based on the concentration values of one of the analytes (sodium, for the purposes of this example), and then, the sorted paired data is divided into n bins. Next, 1.25% of patients with the lowest sodium concentration values and 1.25% of patients with the highest sodium concentration values are eliminated from each bin. The lowest and highest sodium values for the remaining 97.5% of patients represent the lowest and highest thresholds of the confidence interval (i.e., the 1.25% and 98.75% confidence limits). Similarly, if a 95% confidence interval is determined, 2.5% of patients with the lowest sodium concentration values and 2.5% of patients with the highest sodium concentration values are eliminated from each bin of data.

If the paired data is sorted according to chloride concentration, then the 1.25% of patients with the lowest chloride concentration values and 1.25% of patients with the highest chloride concentration values are eliminated, in order to establish a 97.5% confidence interval.

At a given level of confidence, and all other things being equal, a result with a smaller confidence interval is more reliable than a result with a larger confidence interval.

In one embodiment, the confidence interval used in the present invention is the central 90% confidence interval, the central 92.5% confidence interval, the central 95% confidence interval, the central 97.5% confidence interval, or the central 99% confidence interval.

As used herein, a “likelihood distribution” means a distribution of paired (or two or more) analyte concentration values, whereby the distribution corresponds to appropriate (valid) analyte concentration measurements. Data falling outside the likelihood distribution is likely in error. In one embodiment, the likelihood distribution is established by fitting a curve to the lower and upper confidence limits associated with each data bin. The two curves are the boundaries of the distribution. In another embodiment, the likelihood distribution is established by the upper and lower confidence limits for each analyte bin, and curves are not fit to the data.

A “predetermined likelihood distribution,” as used herein, refers to a likelihood distribution that was calculated either by the user of the invention or a third party. The likelihood distribution provides a space of paired analyte (i.e., first and second) concentration values, and paired data points falling within the space are likely valid, while paired concentration data points falling outside the space are likely in error. The likelihood distribution can be calculated according to the user's preference. For example, concentration data for the first and second analytes can be obtained, e.g., from a database, sorted into bins or groups, and confidence intervals for the sorted bins or groups can then be calculated. Data points falling within the intervals are likely valid.

A likelihood distribution can also be calculated for three or more analytes, and can be calculated by the user of the invention or a third party.

“Analyte” as used herein, refers to a substance, e.g., ion or molecule, whose abundance/concentration is determined by some analytical procedure. For example, in the present invention, an analyte can be an ion, protein, peptide, nucleic acid, lipid, carbohydrate or small molecule. Reference is made throughout the specification to “first analyte” and “second analyte.” The designation of “first analyte” and “second analyte” is based on how the likelihood distribution is established, and therefore, how the paired analyte data is originally sorted. To establish a likelihood distribution, in one embodiment, paired analyte data is sorted into bins (e.g., 10, 20, 30, or 40 bins) according to the concentration values of one of the analytes. For the purposes of the invention, this analyte is designated the “second analyte.” The user of the invention determines which analyte to use to sort the paired concentration data. In one embodiment, the paired analytes are sodium and chloride. In a further embodiment, the paired analyte data is sorted according to sodium concentration. In this embodiment, sodium is the “second analyte” and chloride is the “first analyte.” In another embodiment, the paired analyte data is sorted according to chloride concentration. In this embodiment, chloride is the “second analyte” and sodium is the “first analyte.”

As used herein, “analyte standard” and “calibration standard” are synonymous, and each refers to an analyte sample used to correct for any measurement bias between different instruments. In one embodiment, the concentration of an analyte standard is measured by at least 2 instruments. The difference in concentrations measured by the 2 instruments, in this embodiment, serves as the basis for a correction factor. In a further embodiment, the concentration is an average of concentrations taken over a series of measurements.

Analytes for Use with the Present Invention

The present invention makes use of analyte concentration data for two or more analytes whose measured concentrations or abundance are positively or negatively correlated (i.e., a concentration or abundance relationship). Although the invention is described mostly with analytes having known concentration relationships, e.g., sodium and chloride, the invention is not limited thereto. For example, data mining can be employed to search for analyte concentration (or abundance) relationships and global patterns that exist in large databases, but are hidden and not obvious due to the vast amount data (Kazmierczak et al. (2007). Clin Chem Lab Med, V. 45, pp. 749-752). If a relationship is found between concentration or abundance levels of two analytes, or two or more analytes (e.g., three analytes), these analytes can be used in the methods of the present invention.

In one embodiment, if no relationship between analyte concentration or abundance data is evident after a data mining process, the analyte concentration data (or abundance data) is log transformed or naturally log transformed to determine whether a relationship exists. In another embodiment, the concentration data of only one of the analytes is log transformed or naturally log transformed to determine whether a relationship exists.

In one embodiment, the analyte concentration relationship is determined by assembling a data set of paired analyte concentration data, and determining whether a correlation exists. In another embodiment, the data is already assembled. A nonlimiting list of analyte pairs for use with the present invention is provided below.

### Sodium/Chloride

Sodium and chloride constitute the major extracellular ions present in blood. Physiologic factors that affect chloride concentration also effect sodium concentration in a similar manner. Accordingly, in one embodiment, the relationship between sodium and chloride concentrations is used to evaluate the likelihood that a patient's measured sodium concentration is valid or accurate when compared with the patient's measured chloride concentration. In another embodiment, the relationship between sodium and chloride levels is used to evaluate the likelihood that a patient's measured chloride concentration is valid or accurate when compared with the patient's measured sodium concentration.

### Calcium/Albumin

Calcium is important for a variety of physiologic processes. In blood, a significant portion of calcium is complexed to the protein albumin. Thus, patients that show lower than normal albumin concentrations typically show lower than normal calcium concentrations. Conversely, as the albumin concentration increases, there is a corresponding increase in the measured calcium concentration. Therefore, in one embodiment, the relationship between calcium and albumin concentrations is used to evaluate the likelihood that a patient's measured calcium concentration is valid when compared with the patient's measured albumin concentration. In another embodiment, the relationship between calcium and albumin concentrations is used to evaluate the likelihood that a patient's measured albumin concentration is valid or accurate when compared with the patient's measured calcium concentration.

Creatinine is used as an indicator of renal failure, with increased creatinine concentrations, for example, ≧1.5 mg/dL, associated with impairment in renal function. Patients with impaired renal function typically show lower calcium concentrations for a given albumin concentration as compared to individuals with normal renal function. Therefore, in one embodiment, patient calcium and albumin concentration values can be divided into subcategories based on the level of measured creatinine.

### Total Cholesterol/High Density Lipoprotein (HDL)/Low Density Lipoprotein (LDL)

In one embodiment, the relationship between HDL and total cholesterol concentrations is used to evaluate the likelihood that a patient's measured HDL concentration is valid or accurate when compared with the patient's measured total cholesterol concentration. In another embodiment, the relationship between HDL and total cholesterol concentrations is used to evaluate the likelihood that a patient's measured total cholesterol concentration is valid or accurate when compared with the patient's measured HDL concentration.

In yet another embodiment, the relationship between LDL and total cholesterol concentrations is used to evaluate the likelihood that a patient's measured total cholesterol concentration is valid or accurate when compared with the patient's measured LDL concentration. Similarly, the methods of the present invention are employed, in one embodiment, to evaluate the likelihood that a patient's measured LDL concentration is valid or accurate when compared with the patient's measured total cholesterol.

The methods of the present invention can also be employed to evaluate the validity of measured LDL and HDL values, based on the relationship between LDL and HDL levels. In one embodiment, the relationship between LDL and HDL values is used to evaluate the likelihood that a patient's measured HDL level is valid or accurate when compared with the patient's measured LDL value. In another embodiment, the relationship between LDL and HDL values is used to evaluate the likelihood that a patient's measured LDL level is valid or accurate when compared with the patient's measured HDL value.

### Total Protein/Albumin

In one embodiment, the methods of the present invention are used to determine whether a patient's total protein level is accurate or valid (i.e., not in error), based on the patient's albumin levels. In another embodiment, the methods of the present invention are used to determine whether a patient's albumin level is accurate or valid (i.e., not in error), based on the patient's total protein level.

### Direct Bilirubin/Total Bilirubin

Bilirubin is the principle pigment in bile and is derived from the breakdown of hemoglobin. After several degradation steps, free bilirubin becomes bound by albumin and is transported through the blood to the liver. This bilirubin is not soluble in water, and is referred to as insoluble, indirect, or unconjugated. In the liver, bilirubin is rendered soluble by conjugation with glucuronide. The water-soluble bilirubin, called direct or conjugated, is transported along with other bile constituents into the bile ducts, and then to the intestines.

The sum of the direct and indirect forms of bilirubin is termed total bilirubin. Routine analytical procedures exist for the determination of total bilirubin and for the measurement of direct bilirubin. The indirect fraction is obtained by subtracting the direct value from the total value.

In one embodiment, the methods of the present invention are used to determine whether a patient's total bilirubin level is accurate or valid, based on the patient's direct bilirubin level. In another embodiment, the methods of the present invention are used to determine whether a patient's direct bilirubin level is accurate or valid, based on the patient's total bilirubin level.

### Potassium/Total CO₂

Potassium helps to maintain balance of fluids in cells and is involved in enzymatic reactions. Highly elevated potassium levels are associated with both kidney failure and liver disease. Additionally, elevated potassium can lead to heart failure. A decreased potassium level, in some instances, is associated with diabetes, vomitting and/or diarrhea. Blood potassium levels depend on a variety of factors, including aldosterone function, sodium reabsorption and acid-base balance. Common values of serum potassium range from about 3.5 mEq/L to about 5.0 mEq/L.

A patient's CO₂ level is related to the respiratory exchange of carbon dioxide in the lungs and is part of the buffering system of a mammal. When used in conjunction with other electrolytes, A patient's CO₂ level is a good indicator of acidosis and alkalinity.

A normal adult range of total CO₂ is from about 22 mEq/L to about 32 mEq/L. A normal children's range of total CO₂ is from about 20 mEq/L to about 28 mEq/L.

In one embodiment, the relationship between potassium and total CO₂ levels is used to evaluate the likelihood that a patient's measured potassium level is valid or accurate when compared with the patient's measured CO₂ level. In another embodiment, the relationship between potassium and total CO₂ levels is used to evaluate the likelihood that a patient's measured CO₂ level is valid or accurate when compared with the patient's measured potassium level.

### Chloride/Total CO₂

In one embodiment, the relationship between chloride and total CO₂ levels is used to evaluate the likelihood that a patient's measured chloride level is valid or accurate when compared with the patient's measured CO₂ level. In another embodiment, the relationship between chloride and total CO₂ levels is used to evaluate the likelihood that a patient's measured CO₂ level is valid or accurate when compared with the patient's measured chloride level.

### Blood Urea Nitrogen (BUN)/Creatinine

Both BUN and creatinine are filtered by the glomerulus. In normal serum, BUN is present from about 7 mg/dL to about 30 mg/dL; and creatinine is present from about 0.7 mg/dL to about 1.2 mg/dL. The normal range of BUN: creatinine is from about 10-20:1. This range indicates that BUN reabsorption is within normal limits. At greater than 20:1, BUN reabsorption is elevated. In contrast, at ratios lower than 10:1, BUN reabsorption is reduced, which may be indicative of renal damage.

In one embodiment, the relationship between BUN and creatinine levels is used to determine the likelihood that a patient's measured BUN level is valid or accurate when compared with the patient's measured creatinine level. In another embodiment, the relationship between BUN and creatinine levels is used to determine the likelihood that a patient's measured creatinine level is valid or accurate when compared with the patient's measured BUN level.

### Aminotransferase (AST)/Alanine Aminotransferase (ALT)

The AST/ALT ratio, in some instances, is useful in differentiating between causes of liver damage. For example, when the ratio is greater than 2.0, liver damage is more likely to be associated with alcoholic hepatitis (Am. J. Gastroenterol. 94, pp. 1018-1022). If the ratio is less than 1.0, liver damage is most likely associated with viral hepatitis.

In one embodiment, the relationship between AST and ALT levels is used to determine the likelihood that a patient's measured AST level is accurate or valid when compared with the patient's measured ALT level. Similarly, in another embodiment, the relationship between AST and ALT levels is used to determine the likelihood that a patient's measured ALT level is accurate or valid when compared with the patient's measured AST level.

### Alanine Aminotransferase (ALT)/Alkaline Phosphatase (ALP)

In one embodiment, the relationship between ALT and ALP levels is used to determine the likelihood that a patient's measured ALT level is accurate or valid when compared with the patient's measured ALP level. In another embodiment, the relationship between ALT and ALP levels is used to determine the likelihood that a patient's measured ALP level is accurate or valid when compared with the patient's measured ALT level.

### Alanine Aminotransferase (ALT)/Gamma-Glutamyl Transferase (GGT)

The ratio of serum GGT to ALT is used as a parameter for evaluation of antiviral therapies. A high ratio may indicate alcohol abuse or alcoholic liver disease, as consumption of alcohol leads to an increase in GGT levels. The upper limit for normal GGT is from about 40 U/L to about 78 U/L. Elevated levels of GGT are commonly associated with diseases of the liver, pancreas and biliary system.

In one embodiment, the relationship between ALT and GGT levels is used to determine the likelihood that a patient's measured ALT level is accurate or valid when compared with the patient's measured GGT level. In another embodiment, the relationship between ALT and GGT levels is used to determine the likelihood that a patient's measured GGT level is accurate or valid when compared with the patient's measured ALT level.

### Calcium/Phosphorus

Typically, for a healthy patient, the ratio of calcium to phosphorus in the blood is 2.5:1. Higher or lower ratios may indicate that the patient has a glandular imbalance. A high ratio of phosphorus to calcium sensitizes the body and increases inflammatory tendencies. The ratio is influenced by parathyroid function and food choices.

In one embodiment, the relationship between calcium and phosphorus levels is used to determine the likelihood that a patient's measured phosphorus level is accurate or valid when compared with the patient's measured calcium level. Similarly, in another embodiment, the relationship between calcium and phosphorus levels is used to determine the likelihood that a patient's measured calcium level is accurate or valid when compared with the patient's measured phosphorus level.

### Calcium/Magnesium

For a healthy patient, calcium:magnesium ratio is about 2 to about 1. A ratio outside of this range can lead to health problems, e.g., kidney stones.

In one embodiment, the relationship between calcium concentration and magnesium concentration is used to determine the likelihood that a patient's measured magnesium level is accurate or valid when compared with the patient's measured calcium level. Similarly, in another embodiment, the relationship between calcium concentration and magnesium concentration is used to determine the likelihood that a patient's measured calcium level is accurate or valid when compared with the patient's measured magnesium level.

### Potassium/Creatinine

In one embodiment, the relationship between potassium concentration and creatinine concentration is used to determine the likelihood that a patient's measured potassium concentration is accurate or valid when compared with the patient's measured creatinine concentration. In another embodiment, the relationship between potassium concentration and creatinine concentration is used to determine the likelihood that a patient's measured creatinine concentration is accurate or valid when compared with the patient's measured potassium concentration.

### Creatine Kinase (CK)/Lactate Dehydrogenase (LDH)

Healthy patients, in some embodiments, present with the following CK and LDH concentrations:

Creatine Kinase (male) about 25 U/L to about 90 U/L

Creatine Kinase (female)—about 10 U/L to about 70 U/L

LDH, serum: about 45 U/L to about 90 U/L.

In one embodiment, the relationship between CK concentration and LDH concentration is used to determine the likelihood that a patient's measured CK concentration is accurate or valid when compared with the patient's measured LDH concentration. In another embodiment, the relationship between CK concentration and LDH concentration is used to determine the likelihood that a patient's measured LDH concentration is accurate or valid when compared with the patient's measured CK concentration.

### Magnesium/Potassium

In one embodiment, the relationship between magnesium concentration and potassium concentration is used to determine the likelihood that a patient's measured magnesium concentration is accurate or valid when compared with the patient's measured potassium concentration. Similarly, in another embodiment, the relationship between magnesium concentration and potassium concentration is used to determine the likelihood that a patient's measured potassium concentration is accurate or valid when compared with the patient's measured magnesium concentration.

### Anion Gap/Potassium

A patient's anion gap level is an approximate measurement of ions present in the blood (both anions and cations). The physiological range for anion gap is typically about 10 MMol/L to about 12 MMol/L.

In one embodiment, the relationship between anion gap and potassium concentration is used to determine the likelihood that a patient's measured anion gap value is accurate or valid when compared with the patient's measured potassium concentration. Similarly, in another embodiment, the relationship between anion gap and potassium concentration is used to determine the likelihood that a patient's measured potassium concentration is accurate or valid when compared with the patient's measured anion gap value.

### Sodium/Potassium

In one embodiment, the relationship between sodium concentration and potassium concentration is used to determine the likelihood that a patient's measured sodium concentration is accurate or valid when compared with the patient's measured potassium concentration. Similarly, in another embodiment, the relationship between sodium concentration and potassium concentration is used to determine the likelihood that a patient's measured potassium concentration is accurate or valid when compared with the patient's measured sodium concentration.

### Chloride/Potassium

In one embodiment, the relationship between chloride and potassium levels is used to determine the likelihood that a patient's measured chloride level is accurate or valid when compared with the patient's measured potassium level. In another embodiment, the relationship between chloride and potassium levels is used to determine the likelihood that a patient's measured potassium level is accurate or valid when compared with the patient's measured chloride level.

### Magnesium/Phosphate

In one embodiment, the relationship between magnesium and phosphate levels is used to determine the likelihood that a patient's measured magnesium level is accurate or valid when compared with the patient's measured phosphate level. In another embodiment, the relationship between magnesium and phosphate levels is used to determine the likelihood that a patient's measured phosphate level is accurate or valid when compared with the patient's measured magnesium level.

### Methods of the Invention

In one embodiment, the present invention provides methods for validating clinical chemistry, diagnostic and point-of-care test results by assessing analyte concentration (or abundance) relationships, between two or more analytes. In a further embodiment, the analyte relationship is between two, three, four or five analytes. In another embodiment, the analyte concentration relationship is for two analytes (analyte pairs), and the analyte pairs are selected from the pairs given above.

### Likelihood Distribution

In order to validate the accuracy of measured analyte values for 2 or more analytes, for example, the validity of measured sodium levels based on measured chloride values (or vice versa), a predetermined likelihood distribution is used, or previously collected data is used to establish a likelihood distribution of paired analyte concentration (or abundance) values. Although the invention is not limited to a particular size of the data set for establishing a likelihood distribution, typically, larger data sets are preferred. For example, in one embodiment, a data from at least about 10,000 patient samples is used to establish the likelihood distribution. In another embodiment data from at least about 20,000 samples, at least about 30,000 samples, at least about 40,000 samples, at least about 50,000 samples, at least about 60,000 samples, at least about 70,000 samples, at least about 80,000 samples, at least about 90,000 samples, at least about 100,000 samples, at least about 110,000 samples, at least about 120,000 samples, at least about 130,000 samples, at least about 140,000 samples, at least about 150,000 samples, at least about 160,000 samples, at least about 170,000 samples, at least about 180,000 samples, at least about 190,000 samples, at least about 200,000 samples, at least about 250,000 samples, at least about 300,000 samples, at least about 350,000 samples, at least about 400,000 samples, at least about 450,000 samples, or at least about 500,000 samples is used to establish the likelihood distribution.

In one embodiment, the likelihood distribution is determined by first sorting the paired analyte data according to the concentration of one of the analytes. For example, in sodium/chloride example, the paired data can be sorted either according to sodium concentration, or according to chloride concentration.

Once the data is initially sorted, obvious outliers, in one embodiment, are excluded from the data set. An outlier, in one embodiment, includes an analyte concentration value which is out of the physiological concentration or abundance range by at least about 50%. Physiological ranges for the analytes used in the present invention are known to those of ordinary skill in the art. In another embodiment, if too few second analyte values exist to establish a reliable confidence interval, paired values with these respective second analyte values are discarded as outliers.

In one embodiment, the paired analyte data is divided into a plurality of bins according to the concentrations of one of the analytes. For example, the paired analyte data, in one embodiment, is divided into at least 10 different bins according to the measured concentrations of one of the analytes, at least 15 different bins according to the measured concentrations of one of the analytes, at least 20 different bins according to the measured concentrations of one of the analytes, at least 25 different bins according to one of the measured concentrations of one of the analytes, at least 30 different bins according to the measured concentrations of one of the analytes, at least 31 different bins according to the measured concentrations of one of the analytes, at least 32 different bins according to the measured concentrations of one of the analytes, at least 33 different bins according to the measured concentrations of one of the analytes, at least 34 different bins according to the measured concentrations of one of the analytes, at least 35 different bins according to the measured concentrations of one of the analytes, at least 36 different bins according to the measured concentrations of one of the analytes, at least 37 different bins according to the measured concentrations of one of the analytes, at least 38 different bins according to the measured concentrations of one of the analytes, at least 39 different bins according to the measured concentrations of one of the analytes or at least 40 different bins according to the measured concentrations of one of the analytes. In yet another embodiment, the analyte data is divided into at least 40 or at least 50 different bins.

In one embodiment, the paired analytes are sodium and chloride. In a further embodiment, the paired concentration data is sorted according to the measured sodium concentrations. In another embodiment, the paired concentration data is sorted according to the measured chloride concentrations.

In another embodiment, the paired analytes are total cholesterol and low density lipoprotein (LDL). In a further embodiment, the paired concentration data is sorted according to the measured LDL concentrations. In another embodiment, the paired concentration data is sorted according to the measured total cholesterol concentrations.

In another embodiment, the paired analytes are total cholesterol and high density lipoprotein (HDL). In a further embodiment, the paired concentration data is sorted according to the measured HDL concentrations. In another embodiment, the paired concentration data is sorted according to the measured total cholesterol concentrations.

In one embodiment, the analyte pair is selected from the pairs provided in the section above.

As stated above, the invention is not limited to the analytes described herein. Any pair of analytes with a concentration or abundance relationship (i.e., already known relationship or a relationship is determined by data mining) can be used with the methods of the present invention.

In one embodiment, the data used to establish the likelihood distribution includes at least about 500,000 paired data points, and the paired data points are sorted into at least about 30 bins, at least about 31 bins, at least about 32 bins, at least about 33 bins, at least about 34 bins, at least about 35 bins, at least about 36 bins, at least about 37 bins, at least about 38 bins, at least about 39 bins, at least about 40 bins, at least about 40 bins or at least about 50 bins.

In one embodiment, the data set used to establish the likelihood distribution includes at least about 10,000 data points or at least about 100,000 paired data points, and the paired data points are sorted into at least about 20 bins, at least about 21 bins, at least about 22 bins, at least about 23 bins, at least about 24 bins, at least about 25 bins, at least about 26 bins, at least about 27 bins, at least about 28 bins, at least about 29 bins or at least about 30 bins, according to the concentrations of one of the analytes (referred to as “the second analyte”).

Once the data is sorted into bins, a confidence interval is determined for the concentration or abundance values of the first analyte associated with each second analyte bin. For example, if the data is sorted in 20 bins, 20 confidence intervals are determined (i.e., one for each bin). As stated above, the data can be sorted according to the concentration (or abundance) values for either analyte, e.g., the data is sorted into chloride bins and a confidence interval is determined for sodium values associated with each respective chloride bin. In an alternative sodium/chloride embodiment, the data is sorted into sodium bins and a confidence interval can be determined for chloride values associated with each respective sodium bin.

In one embodiment, a 90% confidence interval is determined for the first analyte concentrations associated with the second analyte (i.e., the second analyte is how the data was sorted) concentrations. In another embodiment, a 92.5% confidence interval is determined for the first analyte concentrations associated with the second analyte concentrations, for each bin of data. In another embodiment, a 95% confidence interval is determined for the first analyte concentrations associated with the second analyte concentrations, for each bin of data. In even another embodiment, a 97.5% confidence interval or a 99% confidence interval is determined for the first analyte concentrations associated with the second analyte concentrations, for each bin of data.

Once a confidence interval is determined for each bin of data, the upper and lower confidence limits (also referred to herein as “percentile limits”) for the first analyte concentration (associated with the second analyte concentration) are determined. For example, at a 95% confidence level with a lower limit A and higher limit B, 95% of the population lies between A and B. Of the remaining 5% of values, 2.5% are less than A and 2.5% are greater than B. Accordingly, for a 95% confidence interval, the confidence limits are referred to as the 2.5% limit and the 97.5% limit. The analyte concentration values associated with these limits are used to establish the boundaries of the likelihood distribution. Values that fall below the lower limits or above the upper limits most likely represent true measurement errors.

For a 97.5% confidence interval, with a lower limit A and a higher limit B, 97.5% of the population lies between A and B. Of the remaining 2.5% values, 1.25% are less than A and 1.25% are greater than B. Accordingly, the confidence limits for a 97.5% confidence interval are the 1.25% limit and 98.75% limit.

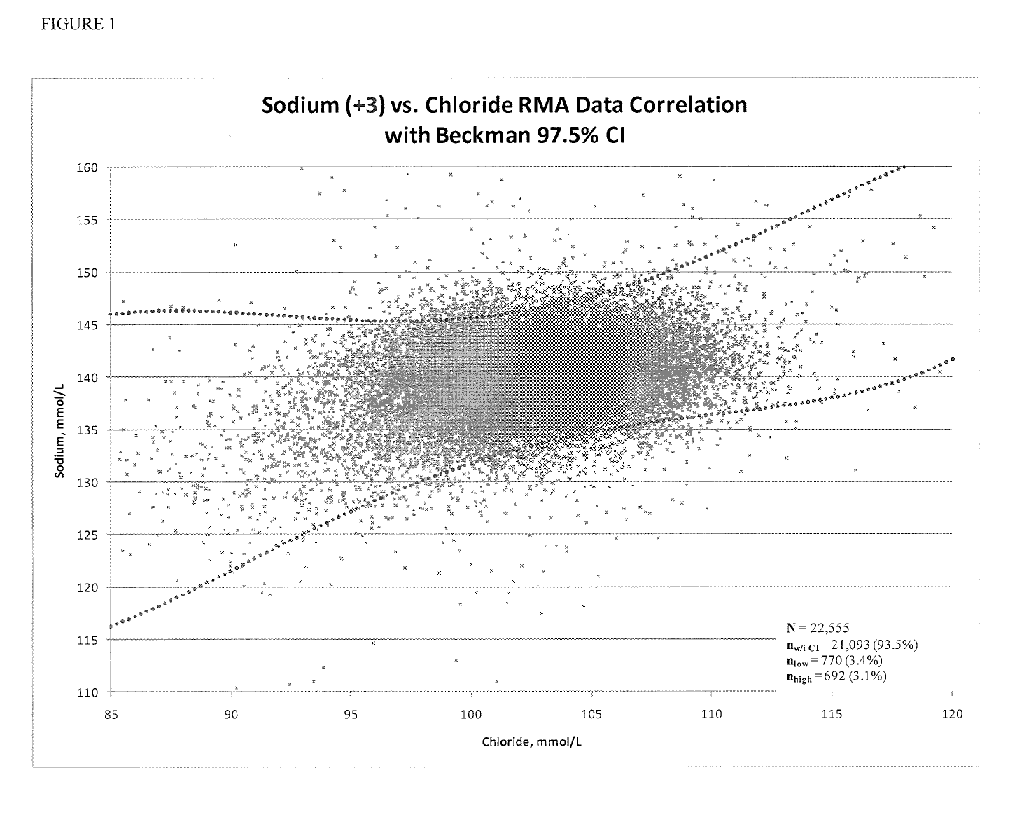

Once the confidence intervals are established for each bin of data, in one embodiment, the upper and lower limits for each interval are plotted graphically (for example, see FIGS. 1-3).

In one embodiment, and regardless of whether the data are plotted graphically, a curve is fit (e.g., a regression curve) to both the upper and lower limits of each respective confidence interval. In this embodiment, the two curves establish the boundaries for the likelihood distribution for the respective paired analyte concentration or abundance data. Data points falling above the upper limit curve or below the lower limit curve are deemed to be invalid or in error.

One of ordinary skill in the art will readily know how to fit the confidence limit data points depending on whether the relationship is linear or nonlinear (e.g., least squares regression, exponential, first degree polynomial, second degree polynomial, third degree polynomial, fourth degree polynomial can be employed to fit the data). Additionally, many statistical packages such as the GNU Scientific Library (gnu.org), SciPy (scipy.org), OpenOpt (openopt.org), MATLAB (Mathworks, Natick, Mass.) and Labview (National Instruments, Austin, Tex.) each contain software for curve fitting and regression analysis. Accordingly, the skilled artisan can use any of these software packages to fit the analyte concentration data.

The skilled artisan is directed to the following resources for guidance on curve fitting, each of which is incorporated herein by reference—Draper, Applied Regression Analysis, Third Edition, Wiley-Interscience (ISBN 0471170828); Cohen et al. Applied Multiple Regression/Correlation Analysis for the Behavioral Sciences, Second edition (ISBN 0805822232); Schittkowski (2002). EASY-FIT: a software system for data fitting in dynamical systems, Structural and Multidisciplinary Optimization, V. 23, pp. 153-169.

In one embodiment, the likelihood distribution is established without fitting a curve to the lower and upper confidence limits. In this embodiment, the upper and lower confidence limits themselves establish the boundaries for the likelihood distribution. Accordingly, data points falling within these boundaries are deemed to be valid or accurate measurements while data points falling outside the boundaries are invalid or inaccurate.

In one embodiment, once a likelihood distribution is established for a given analyte concentration (or abundance) data set, patient data is analyzed against the distribution to determine whether measurements are in error or valid. In a further embodiment, a patient's analyte concentration (or abundance) data that falls within the likelihood distribution is not in error.

Instruments for Use with the Present Invention

In the methods of the present invention, a likelihood distribution is used to validate point-of-care test results for various analytes. If the data to be validated is obtained from a different instrument than the data used to establish the likelihood distribution, a correction factor (also referred to herein as a calibration factor) can be employed to correct for any bias that is introduced by the use of data acquired from different instruments.

In one embodiment, data acquired from multiple instruments, for example, at least 2 or at least 3 instruments, are used to generate a likelihood distribution of paired analyte data points.

In one embodiment, a correction factor is determined by measuring the concentration of an analyte standard (i.e., a calibrator solution) in each instrument. The analyte standard, in one embodiment, is a sample of the second analyte, i.e., the analyte by which the paired analyte concentration values are initially sorted.

For example, in one embodiment, the measured concentration of the calibrator solution is 1 mg/mL in the first instrument, and 0.5 mg/mL in the second instrument. In this embodiment, the correction factor (calibration factor) is 2. If the measured concentration of the analyte standard is the same for both instruments, then no correction factor is needed for that particular analyte (i.e., the correction factor would be 1). In one embodiment, the correction factor is determined by comparing the concentration of an analyte standard in two instruments, and comparing the values. In a further embodiment, the concentration used is an average concentration of at least 2, at least 3, at least 4, at least 5, at least 6, at least 7, at least 8, at least 9 or at least 10 measurements.

In one embodiment, analyte concentration (or abundance) data collected from at least 2, at least 3, at least 4 or at least 5 instruments can be used in the methods of the invention. In embodiments with 3 or more instruments, multiple correction factors are employed, i.e., a correction factor is employed for each instrument.

In one embodiment, analyte concentration (or abundance) data collected from a single instrument are used in order to create a likelihood distribution. In a further embodiment, paired analyte concentration values to be validated, based on the likelihood distribution, are taken from at least 2 or at least 3 different instruments. For example, if the measured concentration of a particular calibrator solution is 1 mg/mL in the first instrument (i.e., the instrument used for the likelihood distribution), and the measured concentration for the same analyte is 0.5 mg/mL in the second instrument, and the measured concentration is 2 mg/mL in the third instrument, the calibration factors are 2 and 0.5 for the second and third instruments, respectively.

In one embodiment, once a correction/calibration factor is determined, the instrument's software employs this factor when arriving at the analyte concentrations of patient samples.

Although the present invention is described mainly for use with either the Beckman D×C or the Abaxis Piccolo Chemistry Analyzer, it is not limited thereto. For example, in one embodiment, the initial likelihood distribution and/or the patient data to be validated, can be ascertained from patient results measured with one or more of the following instruments: Beckman D×C clinical chemistry analyzer (Beckman Coulter, Brea, Calif.), Beckman LX-20 clinical chemistry analyzer (Beckman Coulter, Brea, Calif.), Piccolo Chemistry Analyzer (Abaxis, Union City, Calif.), Vitros 950® chemistry system (Ortho Clinical Diagnostics, Hong Kong) an ADVIA® chemistry system (Siemens, Deerfield, Ill.), a COBAS INTEGRA® (Roche, Basel, Switzerland), a COBAS® modular analyzer (Roche, Basel, Switzerland), a COBAS Fara® (Roche, Basel, Switzerland), a Paramax® instrument, a Radiometer KNA® instrument (Radiometer America, Westlake, Ohio), or any other analyzer known in the art. Additionally, clinical chemistry analyzers are available from Nova Biomedical Corporation, Olympus America, Inc., Shimadzu Corp., Sysmex Corp., Thermo, Fisher Scientific Inc, Vital Scientific B.V., Horiba, Ltd., JEOL Ltd., Abbott Diagnostics and Adaltis Inc.

It is well within the skill or the ordinary skilled analytical chemist to operate the above instruments without undue experimentation.

### Demographic Evaluation

In one embodiment, the methods of the present invention are used to evaluate analyte concentration data from particular demographics. In this embodiment, the methods of the invention are carried out as outlined above. However, prior to establishing the likelihood distribution, the patient data is sorted according to demographics chosen by the user. For example, in one embodiment, patient data can be sorted according to (1) gender; (2) race; (3) renal failure or lack thereof (e.g., by using the patient's measured creatinine levels); (4) liver failure or lack thereof; (5) country of birth; (6) use of a particular mediation(s); (7) results of previous clinical or diagnostic testing; (8) outpatient vs. inpatient; (9) whether the patient is diabetic or not; (10) age groupings, (11) liver disease, (12) alcohol abuse (e.g., for ALT/GGT ratio), etc. Alternatively, the user employs a predetermined likelihood distribution for each demographic.

The above list of demographic examples is not meant to be limiting. The user of the invention can specify a particular demographic that may be relevant.

Once the data is sorted into demographics (e.g., into “subdatabases”), the methods of the invention are carried out as outlined above. The data in each subdatabase is sorted according to the concentration values of the second analyte into a plurality of bins. At this point, in one embodiment, data outliers (as defined above), if present, are immediately discarded from the dataset.

Regardless of whether outliers are discarded, the sorted data is grouped into a plurality of bins, for example, at least 10 different bins, as described above. In a further embodiment, analyte data from each subdatabase are sorted into at least 20, at least 25, at least 30, at least 35, at least 40, at least 45 or at least 50 bins. In one embodiment, the dataset from one subdatabase is sorted into the same number of bins as data in the other subdatabase(s). In another embodiment, the dataset from one subdatabase is sorted into a different number of bins as data in the other subdatabase(s). Depending on the number of data points in each subdatabase, the ordinary skilled artisan will readily know how to appropriately bin the sorted datasets.

A likelihood distribution is then established (for each bin of data in each subdatabase) at a confidence interval of the user's choosing (e.g., a central 95% or central 97.5% confidence interval). The upper and lower limits for each bin's confidence interval, in one embodiment, are then plotted in graphical form. In one embodiment, the upper and lower confidence limits establish the likelihood distribution for each subdatabase.

In another embodiment, a curve (e.g., a regression curve) is fitted to both (1) the lower confidence limits and (2) upper confidence limits (for each demographic) to establish a space of appropriate measurements for each demographic (i.e., the likelihood distribution). Measurements falling outside this space (i.e., either above the upper curve or below the lower curve) are deemed to be in error or invalid.

In one embodiment, once the likelihood distribution is established (either with curve fitting or without), patient analyte data is analyzed against the distribution to determine if the patient analyte data is in error. If the patient analyte data falls within the likelihood distribution, the data is not in error.

If the data to be analyzed is obtained from one or more instruments different from the one used to acquire the data used to establish the likelihood distribution, one or more correction/calibration factors are employed, as described in detail above.

### Three or More Analytes

In one embodiment, the present invention provides methods for validating point-of-care test results based on the assessment of the relationship between three or more analytes. In a further embodiment, the present invention provides methods for validating point-of-care test results based on the assessment of the relationship between three, four or five analytes.

In an embodiment where three analytes are used, patient analyte concentration data is sorted from highest to lowest, or lowest to highest based on the concentration values of one of the analytes. Each analyte concentration of the sorted analyte has associated with it two other analyte concentrations. At this point, in one embodiment, data outliers (as described above) are discarded from the dataset. The concentration data is then divided into a plurality of bins. A central confidence interval is determined for each bin, as described above for paired analytes.

Each confidence interval's lower and upper limits can then be plotted graphically. In one embodiment, the data are plotted on a three dimensional graph, with each axis (i.e., the x, y and z axes) corresponding to the concentration of one of the analytes. The upper and lower confidence limits are used to establish a likelihood distribution, which is used to assess the validity of analyte concentration data for the three analytes, obtained from other patients.

In one embodiment, once the likelihood distribution is established (either with curve fitting or without), patient analyte data is analyzed against the distribution to determine if the patient analyte data is in error. If the patient analyte data falls within the likelihood distribution, the data is not in error.

### Automation of the Methods of the Invention

In one embodiment, the methods provided herein are incorporated into the software of a diagnostic or clinical chemistry instrument. In a further embodiment, the instrument is selected from the instruments provided above. In another embodiment, the methods provided herein are incorporated into middleware to assess the likelihood of the accuracy of the measurement performed by the instrument.

Software products of the invention, in one embodiment, includes computer readable medium having computer-executable instructions for performing the steps of the methods of the invention. Suitable computer readable media include, but are not limited to, CD, CD-ROM, DVD, DVD-ROM, hard-disk drive, flash memory, ROM/RAM, magnetic disk or tape, optical disk, etc.

Computer executable instructions to carry out the methods of the invention may be written in a computer language or combination of several computer languages, as chosen by the user. For example, one or more of the following computer languages can be employed: C, C++, C#, Java, JavaScript, Perl, PHP, Python, Ruby, SQL, Fortran.

### EXAMPLES

The present invention is further illustrated by reference to the following Examples. However, it should be noted that these Examples, like the embodiments described above, are illustrative and are not to be construed as restricting the enabled scope of the invention in any way.

### Example 1

### Validation of Point-of-Care Test Results by Assessment of Expected Relationship Between Sodium and Chloride Concentrations

Sodium and chloride constitute the major extracellular ions present in blood. Physiologic factors that affect chloride concentration also effect sodium concentration in a similar manner. Accordingly, the relationship between sodium and chloride can be used to evaluate the likelihood that a measured sodium concentration is valid or accurate when compared with the measured chloride concentration.

The relationship between sodium concentration and chloride concentration was assessed in order to validate the accuracy/validity of a measured sodium concentration based on a corresponding measured chloride concentration.

Test results from over 500,000 patient samples analyzed with the Beckman D×C clinical chemistry analyzer were used to establish a database of sodium and chloride concentration values.

All samples containing data for both sodium and chloride were sorted according to the measured chloride concentration value. In this example, patient results with chloride values from 85 mmol/L to 120 mmol/L were used. Patients with chloride concentration values above or below this range were discarded as outliers. The paired concentration data was sorted into 36 different bins according to the measured chloride concentration. Each chloride bin contained a range of sodium concentration values, and the number of sodium concentration values associated with each chloride concentration bin ranged from 475 to 38,433.

Next, the central 97.5% confidence interval for sodium concentration values associated with each chloride bin was calculated. The confidence interval was corrected for the known slight bias that exists in analyte concentrations measured with the D×C and Piccolo Chemistry Analyzer. The +3 in the title of the graph in FIG. 1 refers to the fact that Na values measured using the Piccolo are approximately 3 mmol/L higher when compared to measured results obtained with the Beckman analyzer.

The upper and lower confidence limits for each chloride bin's confidence interval (i.e., the 1.25% and 98.75% limits) were then regressed (see the two curves in FIG. 1). The regression curves served as upper and lower boundaries for assessing the accuracy/validity of sodium and chloride concentration data (i.e., the upper and lower boundaries of the likelihood distribution).

### Results

The expected sodium and chloride concentration relationship (see the two curves in FIG. 1 which establish the likelihood distribution) was used to assess the validity or accuracy of sodium and chloride concentration data obtained from 22,555 patient samples measured with the Piccolo Chemistry Analyzer. If the paired concentration data fell above the upper regression curve or below the lower regression curve (FIG. 1), the data was deemed to be inappropriately high or low, respectively.

It was found that 3.4% of sodium concentration results were inappropriately high and 3.1% of sodium concentration results were inappropriately low when compared to the expected statistical relationship (FIG. 1). While the vast majority of sodium concentration values identified as invalid were barely outside the range of expected probability, there were a number of results where the sodium and chloride concentration relationship was statistically impossible and represented true errors (FIG. 1).

Based on these results, the method outlined herein for validating point-of-care patient data is a robust technique for identifying probable error. The algorithm for identifying error is easily automated into middleware software used to handle point-of-care data, and can potentially be incorporated into the software of the instrument itself.

### Example 2

### Evaluation of the Likelihood of Error in a Measured Sodium Value Based on a Measured Chloride Value, According to Whether a Patient is in the Hospital (Inpatient), or Out of the Hospital (Outpatient)

The relationship between sodium concentration and chloride concentration was assessed in order to establish a range of valid sodium and chloride concentration values.

Test results from over 500,000 patient samples analyzed with the Beckman D×C clinical chemistry analyzer were used to establish a database of sodium and chloride concentration values. The values in this database were then divided into two subdatabases—(1) results obtained from inpatients and (2) results obtained from outpatients.

For each subdatabase, all samples containing paired concentration data for sodium and chloride were sorted and grouped into 36 different bins according to the measured chloride concentration values. Each bin corresponds to a unique chloride value. In this example, patient results with chloride values from 85 mmol/L to 120 mmol/L were used. Patients with chloride concentration values above or below this range were discarded as outliers.

Next, the central 97.5% confidence interval for sodium concentration values associated with each chloride bin, in each subdatabase, was calculated. Each confidence interval has associated with it an upper and lower confidence limit. For the 97.5% confidence intervals established for the bins in each subdatabase, each upper limit is the 98.75% confidence limit for the respective bin and the lower limit is the 1.25% confidence limit for the respective bin.

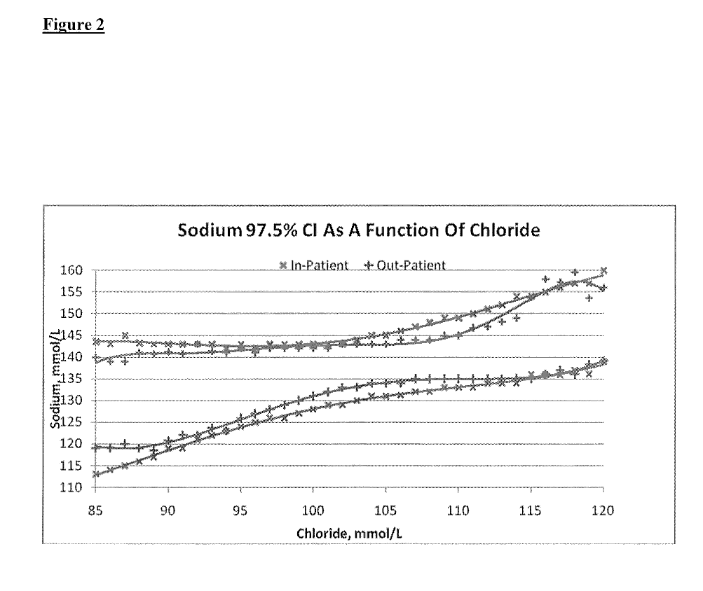

The 1.25% limit and 98.75% limits for sodium concentration at each incremental chloride concentration (i.e., each chloride concentration bin) were determined, and plotted graphically (FIG. 2). For the inpatient data, the 1.25% limit for sodium concentration values associated with a chloride of 85 mmol/L was 113 mmol/L, and the 98.75% limit for sodium concentration values associated with a chloride of 85 mmol/L was 144 mmol/L (FIG. 2)

The upper and lower limits for each subdatabase were then regressed to establish the upper and lower boundaries of the analyte concentration likelihood distribution (FIG. 2). The likelihood distribution established the range of expected sodium values at a specific measured chloride value, for each of the patient demographics.

For inpatients (“×values” in FIG. 2), measured sodium values that fall above the lower regression curve, and below the upper regression curve, at each corresponding measured chloride value, would be deemed to be acceptable. Accordingly, sodium concentration values that fall below the lower regression curve, or above the upper regression curve would be considered to have a high likelihood of measurement error. For example, in FIG. 2, an inpatient with a chloride concentration of 105 mmol/L and a sodium of 120 mmol/L, the sodium value falls below the lower regression curve and would be considered to have a high probability of error.

Similarly, for outpatients (“+values” in FIG. 2), measured sodium values that fall above the lower regression curve, and below the upper regression curve, at each corresponding measured chloride value, would be deemed to be acceptable or accurate. For example, in FIG. 2, an outpatient with a chloride concentration of 105 mmol/L and a sodium of 130 mmol/L, the sodium value falls below the lower regression curve and would be considered to have a high probability of error.

### Example 3

### Method for Evaluating the Likelihood of Error in Measured Calcium Concentration Values Based on Measured Albumin Values, According to Patients' Creatinine Concentrations

Test results from approximately 500,000 patients that included creatinine, calcium and albumin concentration values were assembled.

The patient data was sorted into two subdatabases. Patients with normal creatinine concentrations (<1.5 mg/dL) were grouped into one subdatabase, and those with creatinine concentrations from 1.5 to 3.0 mg/dL were grouped into a second subdatabase.

For each subdatabase, all samples containing data for both calcium and albumin were sorted according to the measured albumin concentration. In this example, patient results with albumin values from 1.0 to 5.0 g/dL were sorted. Patient samples with values outside this range were discarded as outliers due to the fact that too few patients had albumin concentration values above and below these values to establish a reliable confidence interval. The patient data in each subdatabase was sorted into 40 different albumin bins.

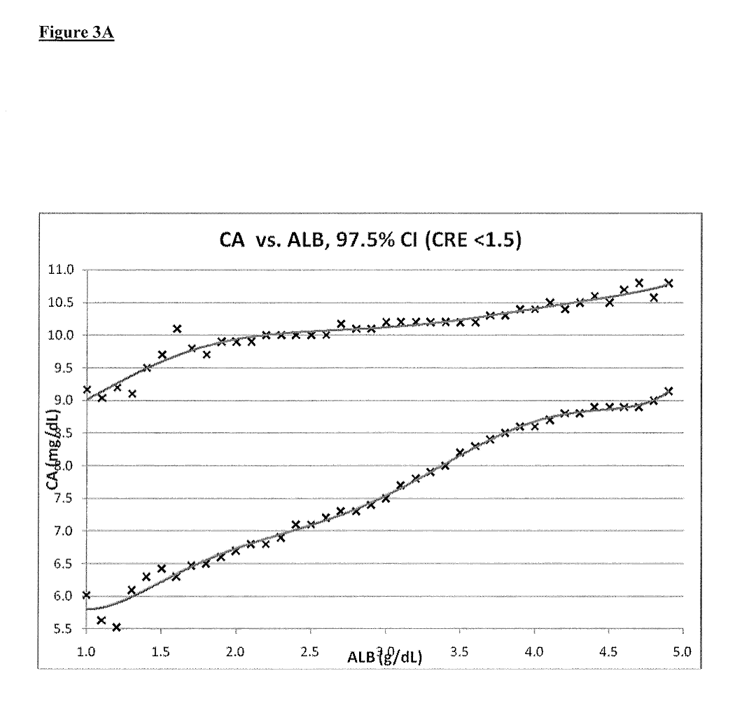

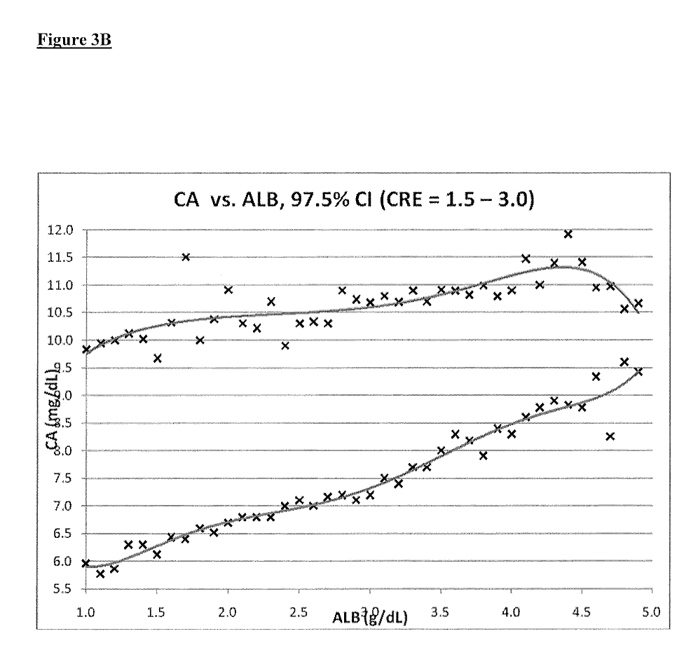

Next, the 97.5% confidence interval for calcium concentration values associated with each albumin concentration value was calculated, for the values in each subdatabase (FIGS. 3A and 3B).

The 1.25 and 98.75 percentile limits for calcium concentration at each incremental albumin concentration were determined, and graphically plotted (FIGS. 3A and 3B). Calculation of the 1.25 and 98.75 percentile limits for calcium values associated with albumin concentration (from 1.0 to 5.0 g/dL) resulted in a distribution showing the range (97.5% confidence interval) of expected calcium values at a specific measured albumin concentration (FIGS. 3A and 3B). For patients with creatinine<1.5 g/dL, the 1.25 percentile for sodium values associated with an albumin of 3.0 g/dL is 7.5 mg/dL and the 98.75 percentile for calcium values associated with an albumin of 3.0 g/dL is 10.1 g/dL.

Separate graphs were constructed based on the demographic of measured creatinine concentration. FIG. 3A shows the relationship between albumin and calcium for creatinine values less than 1.5 mg/dL. FIG. 3B shows this same relationship for patients with creatinine concentrations of 1.5 to 3.0 mg/dL.

Patents, patent applications, publications, product descriptions, and protocols which are cited throughout this application are incorporated herein by reference in their entireties.

The embodiments illustrated and discussed in this specification are intended only to teach those skilled in the art the best way known to the inventors to make and use the invention. Modifications and variation of the above-described embodiments of the invention are possible without departing from the invention, as appreciated by those skilled in the art in light of the above teachings. It is therefore understood that, within the scope of the claims and their equivalents, the invention may be practiced otherwise than as specifically described.

1. A method for determining the validity of a first clinical test result comprising comparing the first clinical test result of a first analyte and its corresponding second clinical test result of a second analyte to a predetermined likelihood distribution for the first analyte and second analyte, and determining the validity of the first clinical test result based on its relationship with the likelihood distribution.

2. The method of claim 1, further comprising obtaining the first clinical test result and its corresponding second clinical test result.

3. The method of claim 1, wherein the first clinical test result is invalid if it is outside of the predetermined likelihood distribution and valid if it is inside of the predetermined likelihood distribution.

4. The method of claim 1, wherein the first analyte and the second analyte is selected from the group consisting of direct bilirubin/total bilirubin, HDL/total cholesterol, LDL/total cholesterol, HDL/LDL, albumin/calcium, sodium/chloride, BUN/creatinine, AST/ALT, total protein/albumin, potassium/total CO₂, calcium/phosphorus, calcium/magnesium, potassium/creatinine, magnesium/potassium, Anion gap/potassium, sodium/potassium, chloride/potassium, magnesium/phosphate, ALT/GGT, ALT/ALP, CK/LDH and chloride/total CO₂.

5. A database comprising a collection of predetermined likelihood distribution for a first analyte and its corresponding second analyte, wherein the clinical test result of the first analyte correlates with the clinical test result of the second analyte.

6. The database of claim 5 in computer readable medium.

7. A method of determining a likelihood distribution for a first analyte clinical test result and its corresponding second analyte clinical test result comprising identifying a plurality of clinical test results for the first analyte and its corresponding second analyte, sorting the clinical test results based on the results for the second analyte, grouping the sorted data into a plurality of bins, identifying a confidence interval for the first analyte clinical test result values for each bin, and determining the likelihood distribution based on the clinical test results within the confidence intervals.

8. The method of claim 7, wherein the first analyte and its corresponding second analyte are selected from the group consisting of direct bilirubin/total bilirubin, HDL/total cholesterol, LDL/total cholesterol, HDL/LDL, albumin/calcium, sodium/chloride, BUN/creatinine, AST/ALT, total protein/albumin, potassium/total CO₂, calcium/phosphorus, calcium/magnesium, potassium/creatinine, magnesium/potassium, Anion gap/potassium, sodium/potassium, chloride/potassium, magnesium/phosphate, ALT/GGT, ALT/ALP, CK/LDH and chloride/total CO₂.
